(19) United States
(12) Patent Application Publication
(10) Pub. No.: US 2023/0187092 A1
(43) Pub. Date: Jun. 15, 2023

(54) Magnetohydrodynamic Cavitation Fusion Energy Generator

(71) Applicants: Ryan S. Wood, Broomfield, CO (US); Kenneth Eugene Kopp, Anaconda, MT (US)

(72) Inventors: Ryan S. Wood, Broomfield, CO (US); Kenneth Eugene Kopp, Anaconda, MT (US)

(21) Appl. No.: 18/145,335

(22) Filed: Dec. 22, 2022

Related U.S. Application Data
(60) Provisional application No. 63/361,429, filed on Dec. 22, 2021.

(51) Int. Cl. G21D 7/02; H02K 44/12; H02K 44/16; H02K 44/10; G21B 1/19

(52) U.S. Cl. CPC G21D 7/02; H02K 44/12; H02K 44/16; H02K 44/10; G21B 1/19; H02K 44/085

(57) ABSTRACT

A magnetohydrodynamic cavitation fusion energy generator comprising an internal armature rotatably arranged within a reactor vessel. The generator further comprises a lithium-ammonia fuel dispersed between the internal armature and the reactor vessel. The reactor vessel further comprises a plurality of external magnets and at least one extraction electrode configured to extract current from fusion reactions in the fuel. The internal armature further comprises a plurality of cavitation cavities, a plurality of internal magnets, and at least one facilitation electrode configured to arc for the facilitation of fusion. The plurality of internal magnets and the plurality of external magnets are arranged relative to one another to create a magnetic field within the reactor vessel when the internal armature is rotated relative to the reactor vessel.

### FIELD OF THE INVENTION

The present invention relates generally to nuclear fusion systems and more specifically to the field of magnetohydrodynamics and aneutronic thermonuclear fusion of liquid metal which converts lithium fusion products into electricity.

### BACKGROUND OF THE INVENTION

Magnetohydrodynamics (MHD) is the study of the magnetic properties and behavior of electrically conducting fluids. Examples of such magneto-fluids include plasmas, liquid metals, salt water, and electrolytes.

The fundamental concept behind MHD is that magnetic fields can induce currents in a moving conductive fluid, which in turn polarizes the fluid and reciprocally changes the magnetic field itself. The set of equations that describe MHD are a combination of the Navier-Stokes equations of fluid dynamics and Maxwell's equations of electro-magnetism.

A variation of MID is an electromagnetic pump, which is a pump that moves liquid metal, molten salt, brine, or other electrically conductive liquid using electromagnetism. A magnetic field is set at right angles to the direction the liquid moves in, and a current is passed through it. This causes an electromagnetic force that moves the liquid. Alternatively, as disclosed in the present application, the electrically conductive liquid can be mechanically pumped generating an electric current that passes through the fluid.

A magnetic field exists along when current is passed through a conductor. When put in an external magnetic field, this current carrying conductor experiences a force that is perpendicular to the directions of both the current and the external magnetic field. This is because the magnetic field produced by the conductor and the external magnetic field in which the conductor is kept may align with each another. An electromagnetic pump uses this principle.

In an electromagnetic power generator, liquid metal is pumped through a perpendicular external magnetic field produced by magnets. The motion of the liquid metal through the magnetic field induces a current in the liquid metal to be passed at right angles to the magnetic field converting the energy in the rotating conductive liquid metal into current. The present application discloses a system that marries the approach of MHD pump to aneutronic fusion in a liquid conductive metal.

Aneutronic fusion is the only type of fusion that can effectively be at the same time—clean, safe, and environmentally friendly, promising a power source to supply the worlds energy needs into the future. There are no greenhouse gases, no neutron emission, no radioactive waste, no thermal waste, no large land areas, no interruption by weather or time of day. It is easy to shut down, with no meltdowns, no proliferation delivering a peaceful and prosperous future to Earth.

Several types of aneutronic fusion have been proposed but the most prevalent concept is a mixture of hydrogen and boron. At extremely high temperatures, hydrogen nuclei (protons) fuse with boron nuclei to form a carbon nucleus very briefly. Since the carbon nucleus has too much energy to stay together, it breaks up into three helium nuclei and releases energy.

Naturally, achieving the necessary temperatures for this process is an engineering challenge and consumes massive amounts of energy, typically through lasers. The difficulty of a fusion reaction is characterized by the ignition barrier, the energy required for the nuclei to overcome their mutual Coulomb repulsion.

The reaction rate of the aneutronic fusion is proportional to the nuclear cross section. In a self-sustaining reaction, the rate of reaction is high enough to maintain the temperature, density and time required to achieve chain reactions above the ignition barrier. Thus, briefly satisfying the Larsson criteria.

The present application discloses a magnetohydrodynanmic cavitation fusion energy generator that overcomes the above-referenced limitations through its unique shape and the specific fuel combination utilized.

### SUMMARY OF THE INVENTION

The present invention is a magnetohydrodynamic cavitation fusion energy generator comprising a reactor vessel, an internal armature rotatably arranged in the reactor vessel, cavitation cavities arranged on the internal armature, a plurality of magnets arranged on both the reactor vessel and the internal armature, and a fuel. The fuel may be a noble gas-lithium-ammonia fuel. The generator may further comprise facilitation electrodes to promote fusion as well as extraction electrodes to extract electricity from the fuel.

The generator of the present invention promotes fusion by using a noble gas-lithium-ammonia fuel that operates in a supercritical fluid state with a density much higher than other known approaches. This fuel exhibits characteristics such as electron screening, tunneling, and Rydberg atom orbitals that lower the coulomb barrier and improve fusion probabilities. The characteristics of the fuel, geometry of the cavitation cavities, and coulomb explosion arcing of between electrodes act in unison to facilitate fusion reactions.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 is a perspective view of the internal armature of the present invention in accordance with at least one embodiment.

FIG. 2 is a front elevation view of the internal armature of the present invention in accordance with at least one embodiment.

FIG. 3 is a top plan view of the internal armature of the present invention in accordance with at least one embodiment.

FIG. 4 is a side elevation view of the internal armature of the present invention in accordance with at least one embodiment.

FIG. 5 is a side section view of the internal armature of the present invention in accordance with at least one embodiment.

FIG. 6 is a perspective view of the reactor vessel of the present invention in accordance with at least one embodiment.

FIG. 7 is a front elevation view of the reactor vessel of the present invention in accordance with at least one embodiment.

FIG. 8 is a top plan view of the reactor vessel of the present invention in accordance with at least one embodiment.

FIG. 9 is a side elevation view of the reactor vessel of the present invention in accordance with at least one embodiment.

FIG. 10 is a side section view of the reactor vessel of the present invention in accordance with at least one embodiment.

FIG. 11 is a perspective view of the internal armature combined with the reactor vessel of the present invention in accordance with at least one embodiment.

FIG. 12 is a side elevation view of the internal armature combined with the reactor vessel of the present invention in accordance with at least one embodiment.

FIG. 13 is a side section view of the internal armature combined with the reactor vessel of the present invention in accordance with at least one embodiment.

FIG. 14 is a perspective view of the reactor vessel of the present invention attached to external components in accordance with at least one embodiment.

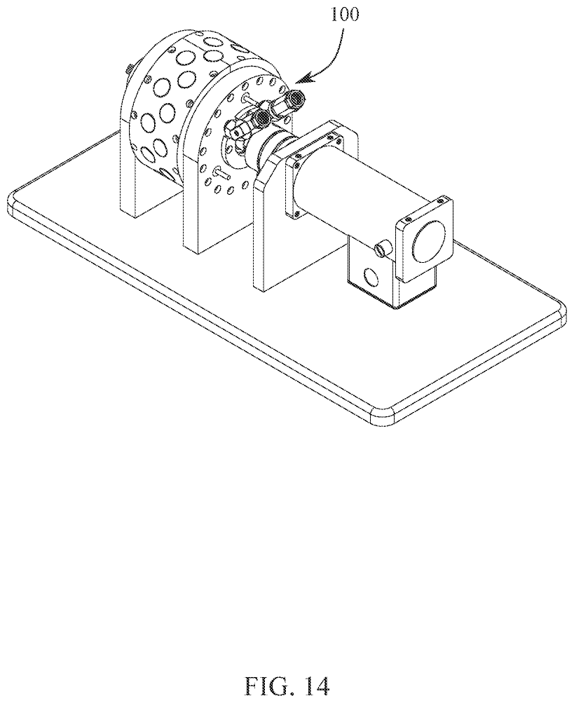

FIG. 15 is a side elevation view of the reactor vessel of the present invention attached to external components in accordance with at least one embodiment.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical” “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of atmospheric water harvesting apparatuses, embodiments of the present disclosure are not limited to use only in this context.

The present invention is a small portable, yet scalable magnetohydrodynamic (MHD) cavitation fusion reactor for generating electricity. The present invention employs a solvated lithium ammonia-noble gas-fuel that is intermittently ignited through a cyclical cavitation process and/or electrical arcing triggering coulomb explosions. The present invention electromagnetically enhances the circulating conductive fuel. The magnetohydrodynamic aspect of the reactor allows for extraction of energy from the fuel through electrical conductors.

Referring now to the figures of the present disclosure. The reactor of the present invention comprises a reactor vessel 100, an internal armature 200, a plurality of magnets 300, and a fuel 400.

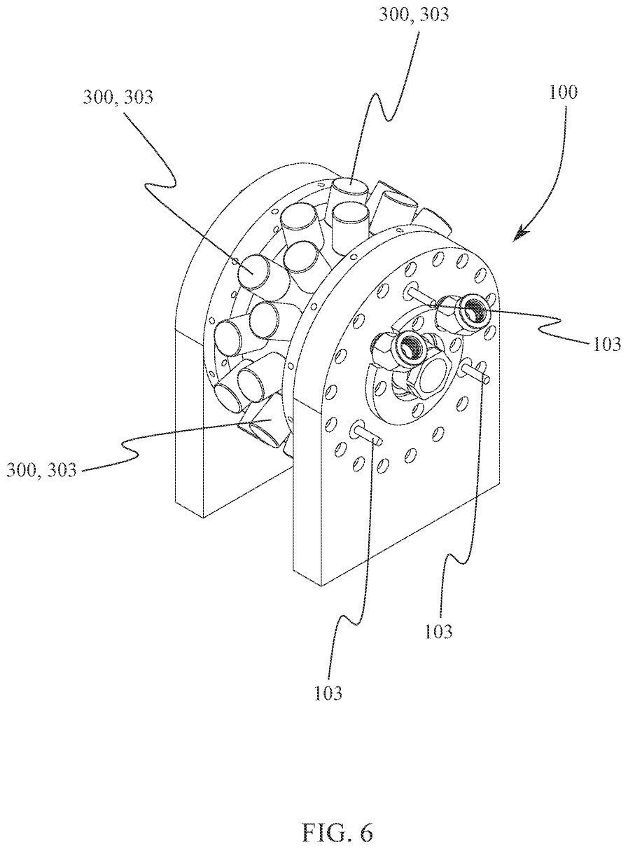

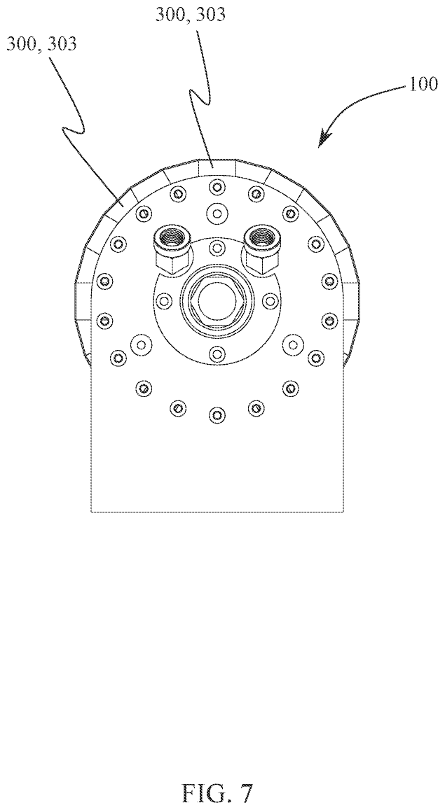

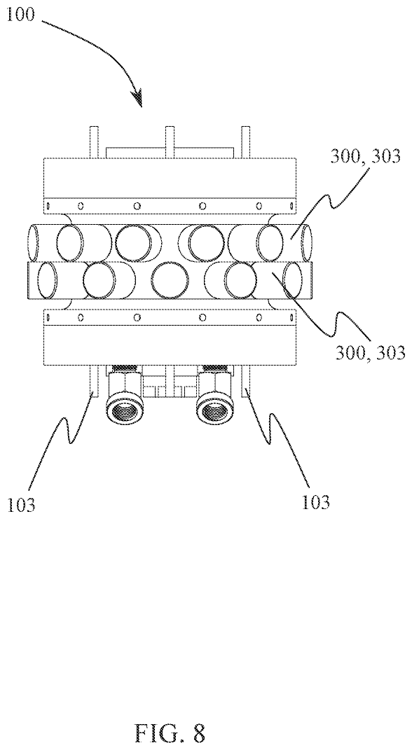

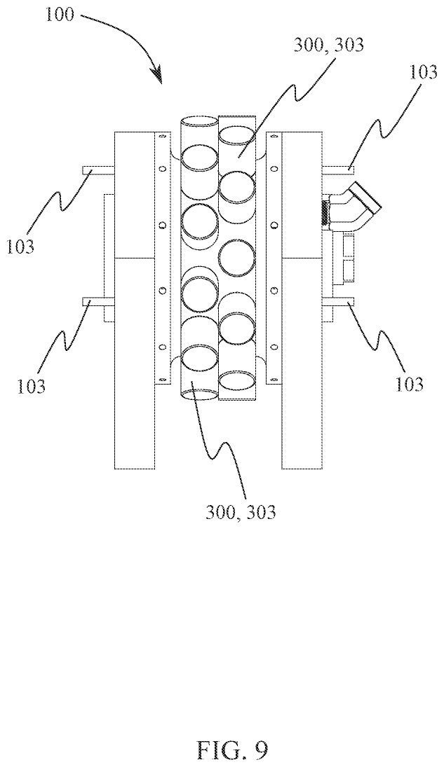

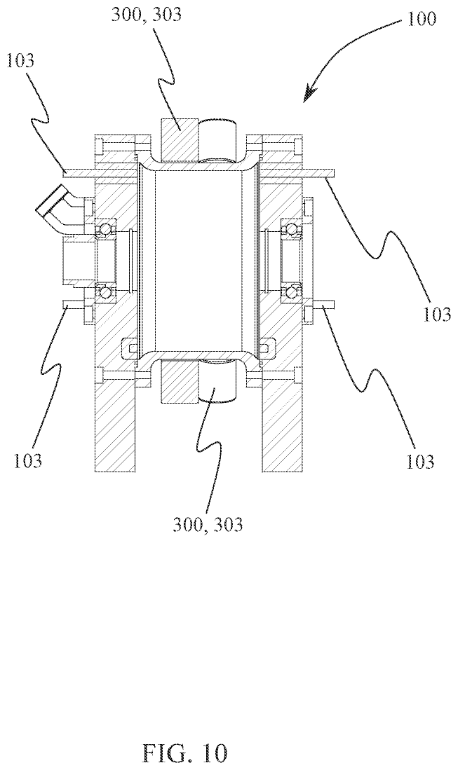

Referring to FIG. 6-10, the reactor vessel 100 of the present invention is a structure having an outer shell and an internal opening configured to house the internal armature 200 and the fuel 400 of the present invention. The plurality of magnets 300 of the present invention comprises a plurality of internal magnets 301 and a plurality of external magnets 303. The plurality of magnets 300 may be permanent magnets or electromagnets. The plurality of external magnets 303 are arranged on the reactor vessel. In the preferred embodiment, as shown in FIG. 6, the plurality of external magnets 303 are arranged in two offset rows, encircling the reactor vessel. The reactor vessel 100 further comprises at least one extraction electrode 103. The at least one extraction electrode 103 is configured to extract current from fusion reactions in the fuel. The at least one extraction electrode 103 may be arranged perpendicular to the flow of fuel within the reactor vessel 100. The motion of the liquid metal fuel 400 through a magnetic field induces a current in the fuel 400 to be passed at right angles to the at least one extraction electrode 103, converting the energy in the rotating conductive liquid metal into current. As shown in FIG. 9, the at least one extraction electrode 103 may comprise an anode at one end of the reactor vessel 100 and a cathode at the opposite end of the reactor vessel 100. As shown in FIG. 10, the at least one extraction electrode 103 extends from the internal opening of the reactor vessel 101 past the outer shell of the reactor vessel 101. To harness electricity from the reactor of the present invention, a power conversion device may be connected to the at least one extraction electrode 103 to process and rectify the power (current, voltage, frequency, and phase) to match useful commercial loads and application via widely available power electronics. Further, the reactor vessel 100 may comprise at least one access port for feeding the fuel 400 into the internal opening of the reactor vessel 100.

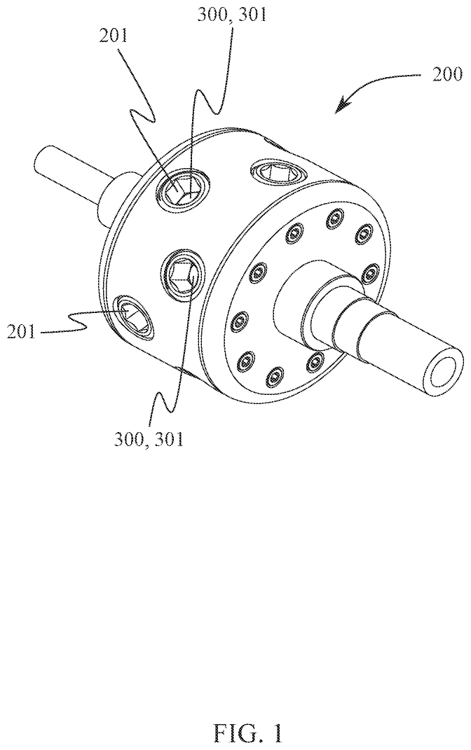

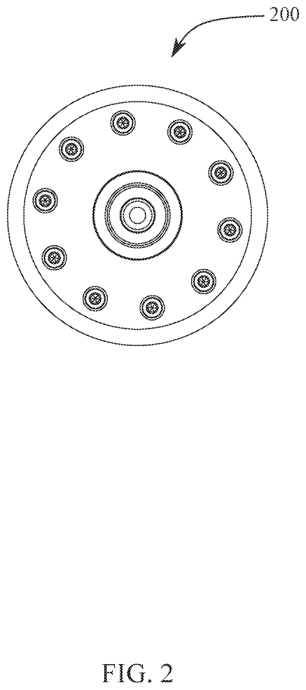

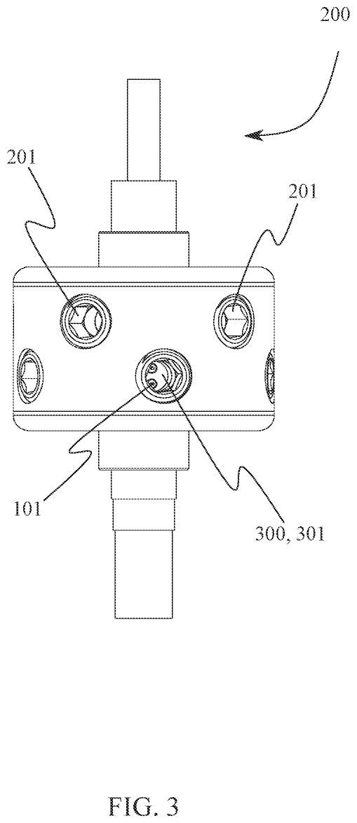

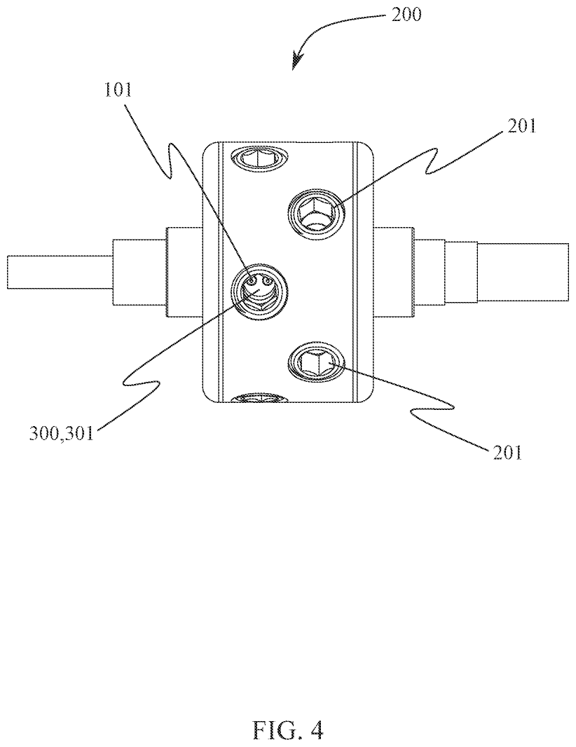

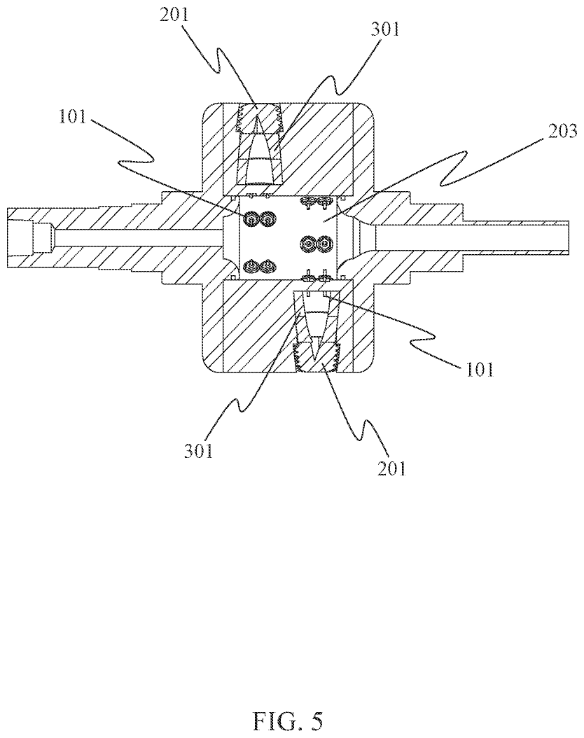

Referring to FIG. 1-5, the internal armature 200 of the present invention is a substantially cylindrical structure configured to be positioned within the reactor vessel 100 and to rotate relative to the reactor vessel 100. The internal armature 200 comprises a plurality of cavitation cavities 201 and the plurality of internal magnets 301. The plurality of cavitation cavities 201 and the plurality of internal magnets 301 are arranged on the internal armature 100. The plurality of cavitation cavities is a series of voids cutting into the surface of the internal armature 200. The presence of the plurality of cavitation cavities 201 creates low pressure areas to induce implosions of sufficient temperature and pressure to cause fusion reactions in the fuel 400. In the preferred embodiment, as shown in FIG. 1, the plurality of cavitation cavities 201 are arranged in two offset rows, encircling the internal armature 200. The plurality of internal magnets 301 is preferably arranged within the plurality of cavitation cavities 201. The internal armature 200 may further comprise at least one facilitation electrode 101. The at least one facilitation electrode 101 is configured to arc (create electrical discharge) for the facilitation of fusion reactions in the fuel. In the preferred embodiment, the at least one facilitation electrode 101 is arranged within the plurality of cavitation cavities 201. This combination of the arcing facilitation electrode 101 with the low-pressure cavitation cavity 201 creates an ideal environment for fusion reaction in the fuel 400. As shown in FIG. 5, the internal armature 200 may further comprise a hollow core 203. The hollow core 203 is preferably a conduit running from one end of the internal armature to the other, configured to circulate coolant for temperature moderation of the reactor.

The fuel 400 of the present invention is an electrically conductive fuel designed to form solvated electrons and Rydberg matter. In the preferred embodiment of the present invention, the fuel 400 is a mixture of lithium, ammonia, and noble gas. Specifically, the preferred fuel 400 is XeLi(NH₃). Solvated electrons are a function of the LiNH₃ concentration. The solvation shell consists of 4 NH₃ surrounding each Li cation and the cleaved electron(s) forming Rydberg matter clusters with charge potential wells and multiple negative charges, so the fuel 400 concentration will be maximum electrical conductivity. Preferably, the fuel 400 has a lithium-noble gas molar concentration at or near saturation and has maximum electrical conductivity. Furthermore, the electrons carrying current exhibit electron screening and quantum tunneling to Rydberg matter clusters not adjacent and perhaps 3-4 shells distant. This non-metallic quantum coulomb screening mechanism of charge will allow multiple electrons to occupy the clusters and provide effective electron shielding of the reactants' charges. This is the mechanism to dramatically decrease's the coulomb barrier and enable fusion reactions. Replacing XeLi(NH₃) with XeLi(ND₃) greatly increases primary fusion reaction rate via additional neutrons which is equivalent to approximately 10°times the rate of alpha production for the fuel chaining which is different from the external alpha sources. Electron screening increases the fusion rate in the Li(ND₃) fuel by about the same amount as in the Li(NH₃) fuel. This non-metallic quantum conduction mechanism of charge will allow multiple electrons to occupy the clusters and provide effective electron shielding of the reactants' charges. Among many other reasons, this disclosure uses XeLi—NH₃ in a higher 8 to 21 MPM concentration to achieve the liquid metal state with excellent electrical conductivity. The dissolving of noble gasses and lithium into ammonia in the fuel 400 creates Rydberg matter in which the ammonia forms a shell around the lithium. When energy is imparted on the molecule, high current compresses the molecule, leading to higher fusion potential.

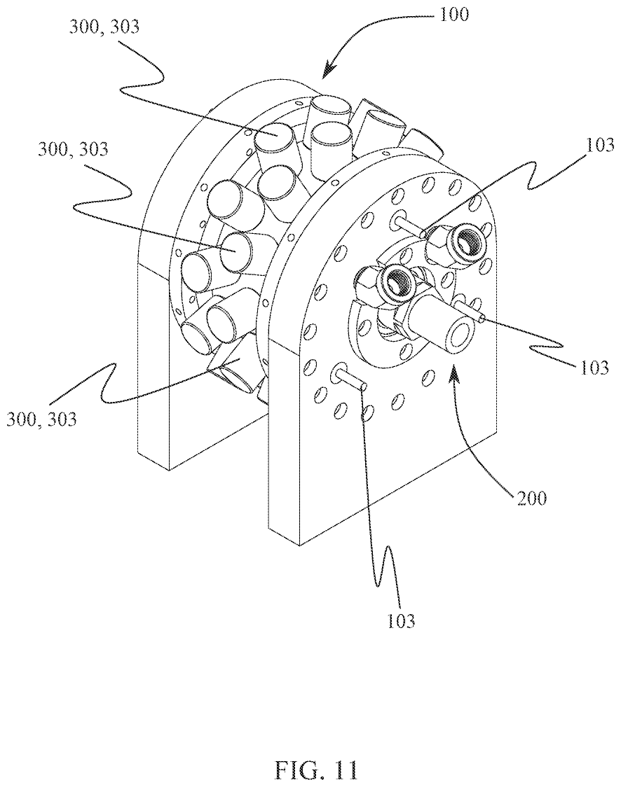

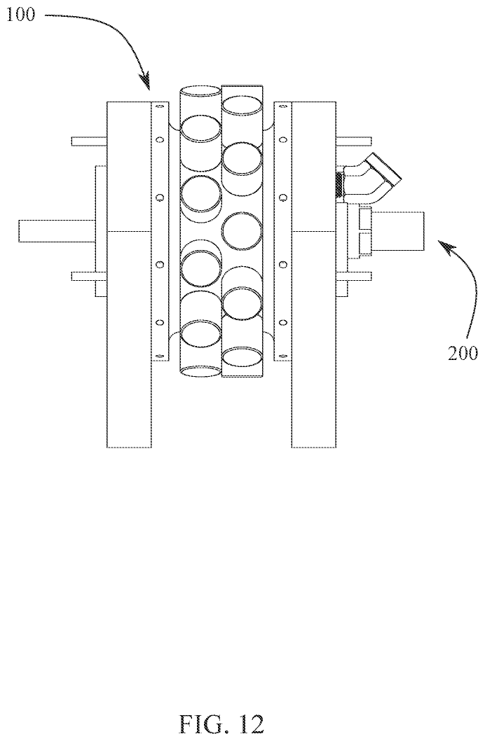

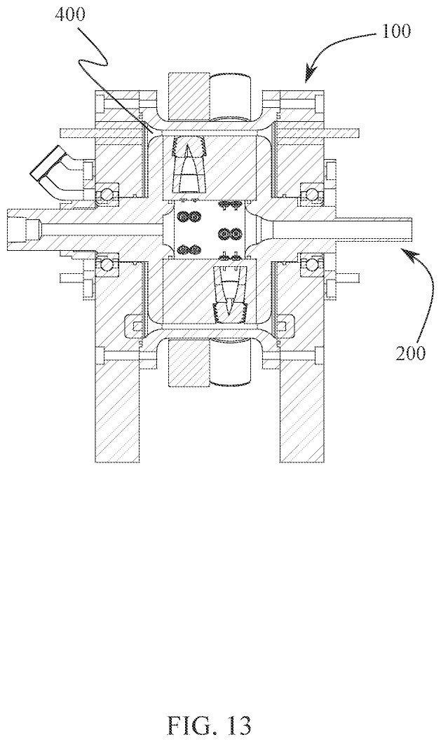

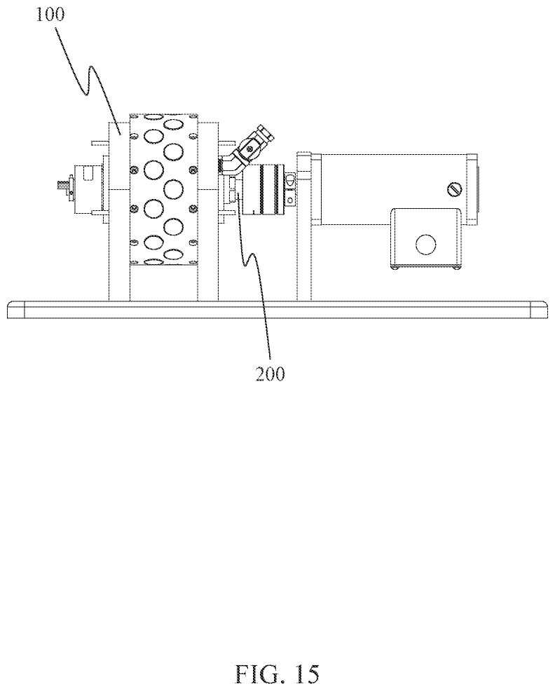

Referring to FIG. 11-13, the internal armature 200 is arranged within the reactor vessel 100 and the fuel 400 in injected into the internal opening of the reactor vessel 100, resting in the space between the internal armature 200 and the reactor vessel 100 and within the plurality of cavitation cavities 201 in the internal armature 200. The internal armature 200 is rotated relative to the reactor vessel 100, circulating the fuel 400 and creating a homogeneous fuel mixture. In the preferred embodiment, the plurality of internal magnets 301 are in line with the plurality of external magnets 303, north to south or reverse. This configuration of the plurality of magnets 300 creates the desired magnetic fields within the reactor vessel 100 as the internal armature 200 is rotated. This arrangement is that the magnetic fields are at right angles to the flow of the fusion fuel 400 within the reactor vessel 100. The fuel 400 operates in a high-density supercritical fluid state. The rotation of the internal armature may be facilitated by an external motor, as shown in FIG. 15. Further, coolant may be cycled through the hollow core 203 of the internal armature 200 as needed to regulate temperature in the reactor. As atoms chain react, they impart electromagnetic energy into the circulated fusion fuel 400 and on the magnetic confinement. This creates a diamagnetic electromagnetic force that is converted to electromotive force and extracted as current from the fuel 400 by the at least one extraction electrode 103.

In some embodiments, the reactor of the present invention includes additional components to aid in the facilitation of fusion reactions. In one embodiment, the fuel 400 may further comprise circulating particles of a radiation source. This radiation source is preferably an alpha radiation source, such as thorium or americium, but may also be a gamma or other radiation source. Another embodiment may include an electrical insulative coating, such as Teflon, on all areas where the fusion fuel 400 may contact, including but not limited to the internal armature 200 and the reactor vessel 100. Further, the reactor vessel and the internal armature may be partially plated with an alpha source, such as thorium, or other radiation source. The addition of alpha sources to the fuel 400, internal armature 200, and reactor vessel 100 amplifies fusion probabilities, while the electrical insulative coating makes the reactor more electrically efficient.

Overall, the present invention uses the power of cavitation and electrical arcing enabling coulomb explosions with solvated electron noble gas-lithium-ammonia fuel 400 to amplify electromagnetic energies within the fuel 400. The fusion of some atoms therefore occurs in the various low pressure implosion cavitation zones in the plurality of cavitations cavities of the reactor of the present invention.

Although the disclosure has been explained in relation to its preferred embodiment, it is to be understood that many other possible modifications and variations can be made without departing from the spirit and scope of the disclosure.

What is claimed is:

1. A magnetohydrodynamic cavitation fusion energy generator, comprising:
a reactor vessel;
an internal armature;
a plurality of cavitation cavities;
a plurality of magnets;
a fuel;
at least one facilitation electrode;
the plurality of magnets further comprising a plurality of internal magnets and a plurality of external magnets;
the internal armature positioned within the reactor vessel;
the plurality of cavitation cavities arranged on the internal armature;
the plurality of internal magnets arranged on the internal armature;
the plurality of external magnets arranged on the reactor vessel;
the fuel dispersed within the reactor vessel; and
the at least one facilitation electrode arranged within the reactor vessel; and
the at least one facilitation electrode configured to arc for the facilitation of fusion.

2. The magnetohydrodynamic cavitation fusion energy generator of claim 1, further comprising:
the fuel being a mixture of noble gas, lithium, and ammonia; and
the fuel further comprising circulating particles of a radiation source.

3. The magnetohydrodynamic cavitation fusion energy generator of claim 1, further comprising:
at least one extraction electrode;
the at least one extraction electrode arranged within the reactor vessel; and
the at least one extraction electrode configured to extract current from fusion reactions in the fuel.

4. The magnetohydrodynamic cavitation fusion energy generator of claim 1, further comprising:
the reactor vessel coated in an electrical insulative coating; and
the internal armature coated in an electrical insulative coating.

5. The magnetohydrodynamic cavitation fusion energy generator of claim 1, further comprising:
the internal armature having a hollow core configured to circulate coolant for temperature moderation.

6. The magnetohydrodynamic cavitation fusion energy generator of claim 1, further comprising:
the reactor vessel partially plated with a radiation source; and
the internal armature partially plated with a radiation source.

7. The magnetohydrodynamic cavitation fusion energy generator of claim 1, further comprising:
the internal armature configured to rotate relative to the reactor vessel;
the plurality of internal magnets arranged within the plurality of cavitation cavities; and
the at least one facilitation electrode arranged within the plurality of cavitation cavities.

8. A magnetohydrodynamic cavitation fusion energy generator, comprising:
a reactor vessel;
an internal armature;
a plurality of cavitation cavities;
a plurality of magnets;
a fuel;
the internal armature positioned within the reactor vessel;
the plurality of cavitation cavities arranged on the internal armature;
the fuel dispersed within the reactor vessel; and
the fuel being a mixture of lithium and ammonia.

9. The magnetohydrodynamic cavitation fusion energy generator of claim 8, further comprising:
at least one facilitation electrode;
at least one extraction electrode;
the at least one facilitation electrode arranged within the reactor vessel;
the at least one extraction electrode arranged within the reactor vessel;
the at least one facilitation electrode configured to arc for the facilitation of fusion; and
the at least one extraction electrode configured to extract current from fusion reactions in the fuel.

10. The magnetohydrodynamic cavitation fusion energy generator of claim 8, further comprising:
the plurality of magnets further comprising a plurality of internal magnets and a plurality of external magnets;
the plurality of internal magnets arranged on the internal armature; and
the plurality of external magnets arranged on the reactor vessel.

11. The magnetohydrodynamic cavitation fusion energy generator of claim 8, further comprising:
the fuel further comprising circulating particles of a radiation source.

12. The magnetohydrodynamic cavitation fusion energy generator of claim 8, further comprising:
the reactor vessel coated in an electrical insulative coating;
the internal armature coated in an electrical insulative coating;
the reactor vessel partially plated with a radiation source; and
the internal armature partially plated with a radiation source.

13. The magnetohydrodynamic cavitation fusion energy generator of claim 8, further comprising:
the internal armature having a hollow core configured to circulate coolant for temperature moderation.

14. The magnetohydrodynamic cavitation fusion energy generator of claim 8, further comprising:
the internal armature configured to rotate relative to the reactor vessel;
the plurality of internal magnets arranged within the plurality of cavitation cavities; and
the at least one facilitation electrode arranged within the plurality of cavitation cavities.

15. A magnetohydrodynamic cavitation fusion energy generator, comprising:
a reactor vessel;
an internal armature;
a plurality of cavitation cavities;
a plurality of magnets;
at least one facilitation electrode;
at least one extraction electrode;
the plurality of magnets further comprising a plurality of internal magnets and a plurality of external magnets;
the internal armature positioned within the reactor vessel;
the plurality of cavitation cavities arranged on the internal armature;
the plurality of internal magnets arranged on the internal armature;
the plurality of external magnets arranged on the reactor vessel;
the at least one facilitation electrode arranged within the reactor vessel;
the at least one facilitation electrode configured to arc for the facilitation of fusion;
the at least one extraction electrode arranged within the reactor vessel;
the at least one extraction electrode configured to extract current from fusion reactions in the fuel; and
the internal armature configured to rotate relative to the reactor vessel.

16. The magnetohydrodynamic cavitation fusion energy generator of claim 15, further comprising:
a fuel;
the fuel dispersed within the reactor vessel;
the fuel being a mixture of noble gas, lithium, and ammonia; and
the fuel further comprising circulating particles of a radiation source.

17. The magnetohydrodynamic cavitation fusion energy generator of claim 15, further comprising:
the reactor vessel coated in an electrical insulative coating; and
the internal armature coated in an electrical insulative coating.

18. The magnetohydrodynamic cavitation fusion energy generator of claim 15, further comprising:
the reactor vessel partially plated with a radiation source; and
the internal armature partially plated with a radiation source.

19. The magnetohydrodynamic cavitation fusion energy generator of claim 15, further comprising:
the internal armature having a hollow core configured to circulate coolant for temperature moderation.

20. The magnetohydrodynamic cavitation fusion energy generator of claim 15, further comprising:
the plurality of internal magnets arranged within the plurality of cavitation cavities; and
the at least one facilitation electrode arranged within the plurality of cavitation cavities.
